(19) United States
(12) Patent Application Publication
(10) Pub. No.: US 2022/0327636 A1
(43) Pub. Date: Oct. 13, 2022

(54) Purchase Receipt Data System

(71) Applicant: Gwendolyn Rhoss, Monroe, NY (US)

(72) Inventor: Gwendolyn Rhoss, Monroe, NY (US)

(21) Appl. No.: 17/711,558

(22) Filed: Apr. 1, 2022

Related U.S. Application Data
(60) Provisional application No. 63/171,839, filed on Apr. 7, 2021.

(51) Int. Cl. G06Q 40/00; G06Q 20/04

(52) U.S. Cl. CPC G06Q 40/123; G06Q 20/047; G06Q 40/10

(57) ABSTRACT

A purchase receipt data system is provided. The purchase receipt data system includes at least one user device. Each user device is capable of connecting to a network. A server is also connected to the network and includes a storage unit and a computer-readable medium. The computer-readable medium is designed to execute an application. The application performs a number of steps, including gathering a set of purchase data, categorizing the set of purchase data, organizing the set of purchase data into a database, and organizing the database into a graphical user interface.

### CROSS REFERENCE TO RELATED APPLICATIONS

This application claims the benefit of U.S. Provisional Application No. 63/171,839 filed on Apr. 7, 2021. The above identified patent application is herein incorporated by reference in its entirety to provide continuity of disclosure.

### BACKGROUND OF THE INVENTION

The present invention relates to a purchase receipt data system. More specifically, the present invention provides a system for extracting, analyzing and present data gathered from purchase receipts from transactions.

Whether one is operating a business or simply managing a personal budget, it is important for her or him to track the outgoing expenditures. Whether by saving physical receipts, copies, or by noting purchase amounts, one must ensure that they are properly noting and categorizing their expenses. Doing so enables the individual managing a budget to analyze spending patterns, determine any needs for spending habit changes, and consolidate expenses into identifiable categories. When taxes are filed for a business or for an individual, these expense amounts and categories are vital for ensuring that an accurate tax return is filed and that the individual will be able to claim any exclusions or deductions as necessary.

Paper receipts, however, can be difficult to store and keep track of. They are made of light-weight material that can be easily torn and are printed with ink that has a tendency to fade over time. In addition to their limited effectiveness as preservable records, receipts are bad for the environment. As retailers have moved in the direction of producing electronic receipts, new challenges to preserving information arises. For example, electronic receipts can clog an email inbox or could be flagged as spam.

Currently, most methods of storing receipt information fail to adequately enable users to keep track of this information. Systems that require manual input of purchase receipt data or require the individual to photograph each purchase receipt, are time-consuming and require a high level of discipline by the user. Furthermore, physical storage methods require an individual to dedicate a potentially significant amount of storage space within a home or business. Physical receipts are also prone to being lost or destroyed or may become disorganized over time. This can incur a significant burden on the individual in terms of taking time to locate lost receipts, reorganize receipts in the event that one or more become displaced, or any other record-maintaining tasks.

Therefore, there is a defined need amongst the known prior art references for an improved system of storing purchase receipt information that is effective, while saving the time and energy of the individual that is in charge of maintaining such purchase records.

### SUMMARY OF THE INVENTION

In view of the foregoing disadvantages inherent in the known types of purchase receipt maintenance and storage systems and methods now present in the prior art, the present invention provides a purchase receipt data system wherein the same can be utilized for providing convenience for the user when analyzing, maintaining and storing purchase receipt data.

The present system comprises at least one user device. The user device is connected to a network. A server is also connected to the network. The server comprises a storage unit and a computer-readable medium stored thereon. The computer-readable medium is configured to execute an application. The application is configured to perform a set of steps. The set of steps comprises, first, gathering a set of purchase data. Second, the set of purchase data is categorized. The categorized purchase data is organized into a database. The database is organized into an interactive graphical user interface, viewable upon the user device.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagrammatic view of an exemplary embodiment of the purchase receipt data system.

FIG. 2 shows a flow chart of the process performed in an exemplary embodiment of the purchase receipt data system.

FIG. 3 shows a demonstrative view of a home screen of an embodiment of the purchase receipt data system.

FIG. 4 shows a demonstrative view of a search screen of an embodiment of the purchase receipt data system.

FIG. 5 shows a demonstrative view of a vendor receipts screen of an embodiment of the purchase receipt data system.

FIG. 6 shows a demonstrative view of an additional material screen of an embodiment of the purchase receipt data system.

FIG. 7 shows a demonstrative view of a tax preparation options screen of an embodiment of the purchase receipt data system.

FIG. 8 shows a demonstrative view of an itemized deductions screen of an embodiment of the purchase receipt data system.

FIG. 9 shows a demonstrative view of an expense dashboard screen of an embodiment of the purchase receipt data system.

FIG. 10 shows a diagrammatic view of a point-of-sale embodiment of the purchase receipt data system.

### DETAILED DESCRIPTION OF THE INVENTION

Reference is made herein to the attached drawings. Like reference numerals are used throughout the drawings to depict like or similar elements of the purchase receipt data system. The figures are intended for representative purposes only and should not be considered to be limiting in any respect.

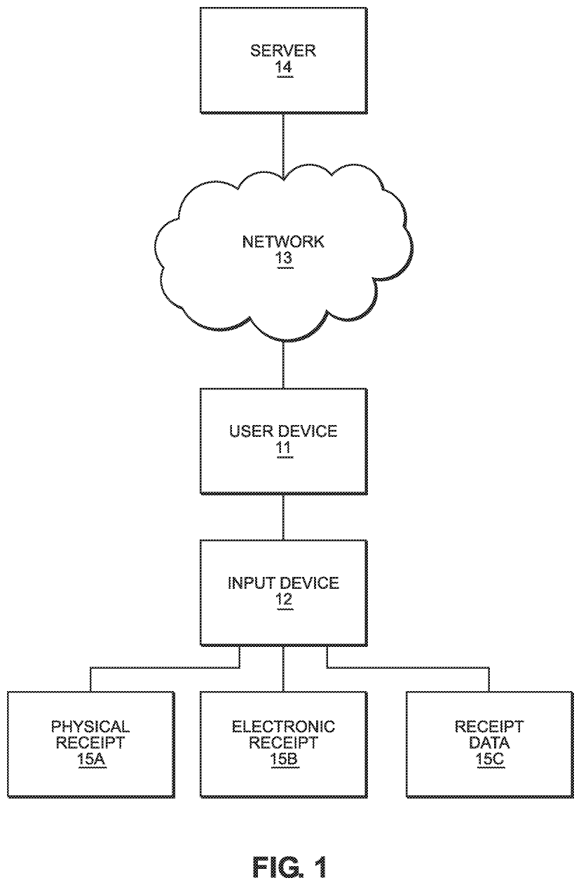

Referring now to FIG. 1, there is shown a diagrammatic view of an exemplary embodiment of the purchase receipt data system. The purchase receipt data system comprises at least one user device 11. The user device 11 may be a mobile phone, a personal computer, or any other device capable of performing the desired functions. Each user device 11 comprises at least one input device 12. The input device 12 is configured to provide a mechanism in which data may be input into the user device 11. For example, the input device 12 may comprise a physical keyboard, a virtual keyboard, a touchscreen, a camera, a scanner and the like. The input device 12 is configured to collect input data in any method. For example, the input device 12 may be configured to gather receipt data 15c from physical receipts 15a such as through a camera or a scanner, but may also be configured to gather receipt data 15c from an electronic receipt 15b.

The purchase receipt data system further comprises a network 13. The user device 11, or user devices 11, are configured to form a data connection with the network 13. For example, the user device 11 may connect to the network 13 via an internet connection (such as a WiFi connection), a wireless data connection (such as a cellular phone network connection) or a short-range data connection (such as a Bluetooth connection). A server 14 is also connected to the network 13, such that a data connection between the user device 11 and the server 14 is defined. The server 14 comprises a storage unit. The storage unit may be an internal storage unit or an external storage unit. The storage unit comprises a computer-readable medium. The computer-readable medium is configured to execute an application stored on the storage unit of the server 14.

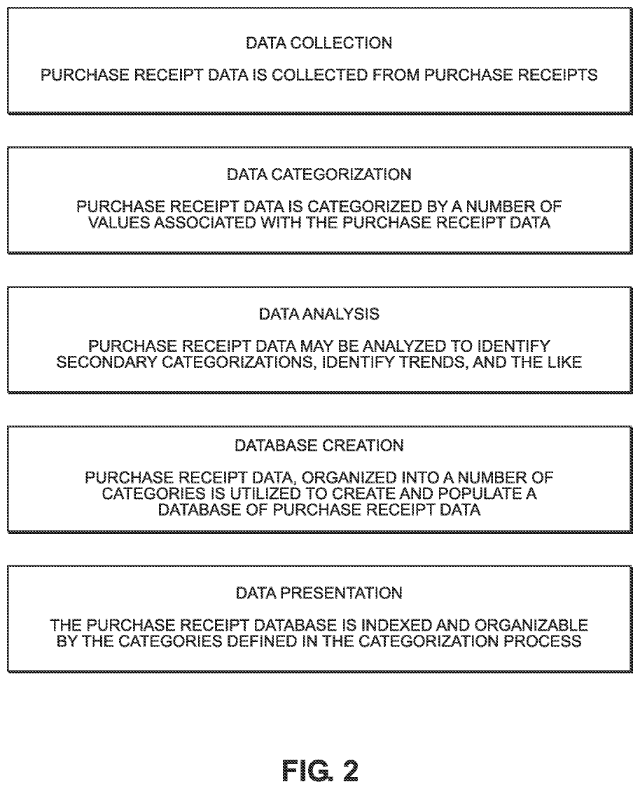

Referring now to FIG. 2, there is shown a flow chart of the process performed in an exemplary embodiment of the purchase receipt data system. The application, stored on the computer-readable medium, is configured to execute a set of steps. The set of steps comprises gathering a set of purchase data. The purchase data is gathered from a number of purchase data receipts. The purchase database receipts may include a plurality of physical purchase receipts generated by a plurality of corresponding purchases. The plurality of physical purchase receipts by using a user device camera to photograph each physical purchase receipt, by scanning the physical purchase receipts with a scanner, by manually inputting the physical purchase receipts, or by any other suitable method. Furthermore, the purchase data may be gathered by a plurality of electronic purchase receipts. The electronic purchase receipts may be imported into the application by associating the application with an email account, may be directly transmitted to the application, or may be uploaded by any other suitable means. In some embodiments, the purchase data may be gathered utilizing artificial intelligence (AI) programs.

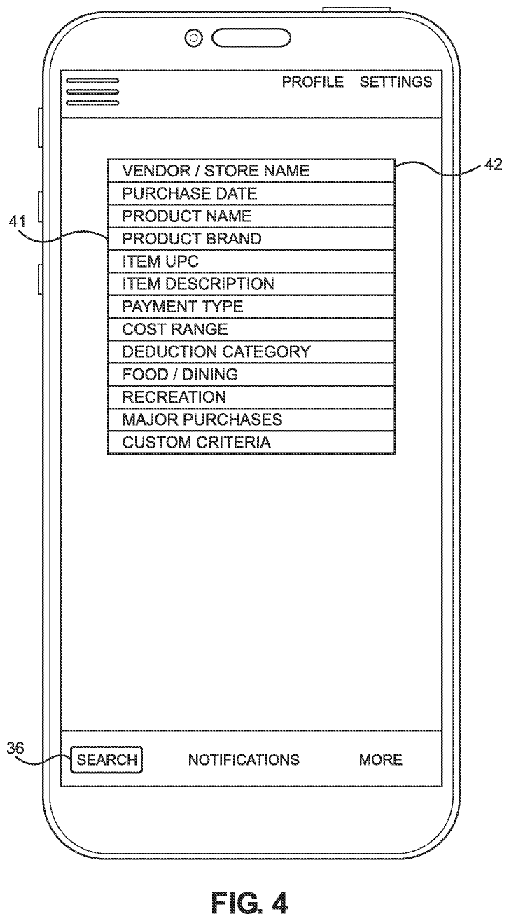

Once the set of purchase data is gathered, the purchase data is categorized. The purchase data may be categorized by any number of desired categories. A number of categories of an exemplary embodiment are shown in FIG. 4. Specifically, the purchase data may be categorized by vendor, by purchase location, by a defined purchase category, by purchase date, or any other desired category. Categorization of purchase data for each purchase will assist the user in classifying each purchase or budgeting or tax purposes. In some embodiments, the purchase data may be categorized utilizing artificial intelligence (AI) programs designed to categorize a purchase based on the presence of one or more identifiers.

Once categorized, the purchase data is organized into a database by at least one category. When the database is prepared, the purchase data is presented to the user via a graphical user interface viewable upon at least one user device. The database, ideally, will be searchable and arrangeable by category, such as to assist individuals in locating a number of purchases corresponding to a specific parameter. For example, an individual may wish to identify the total number of purchases corresponding to a specific vendor, or may desired to identify the total number of purchases categorized as business expenses, compared to personal expenses. The more categorizations that are provided will enable the user to more easily and narrowly identify a desired set of purchase data.

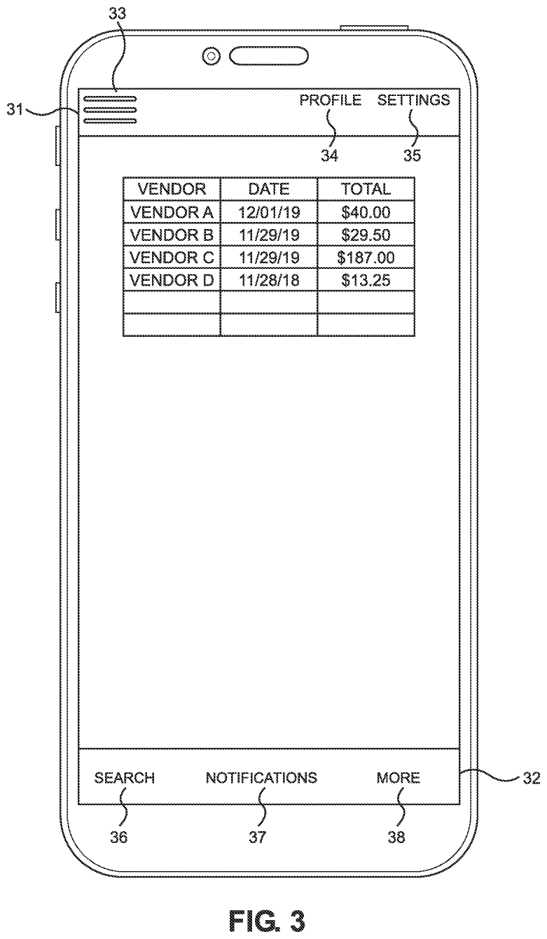

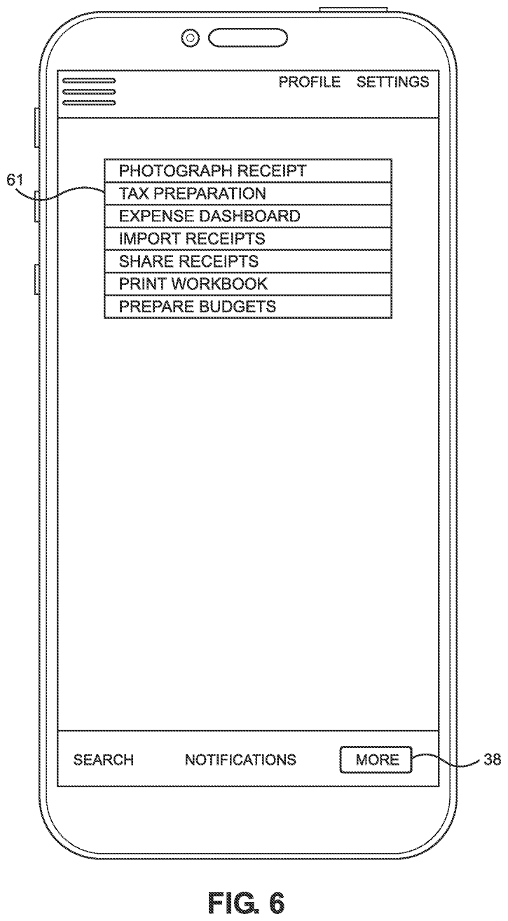

Referring now to FIG. 3, there is shown a demonstrative view of a home screen of an embodiment of the purchase receipt data system application. In the illustrated embodiment, the home screen of the application comprises a top bar 31 and a bottom bar 32. Furthermore, in the illustrated embodiment, the top bar 31 provides a menu selection button 33, a profile button 34, and a settings button 35. Engaging the menu selection button 33 provides the user with a number of menus that he or she may view. Engaging the profile button 34 provides the user with the ability to view or edit any personal information stored on the application. Engaging the settings button 35 enables the user to edit any specific settings associated with the application. Additionally, in the illustrated embodiment, the bottom bar 32 comprises a search button 36, a notifications button 37, and an additional options button 38. A more thorough review of the search button 36 is provided in the FIG. 4 description. Engaging the notifications button 37 enables the user to view any notifications, such as reminders or notices of tax deadlines. A more thorough review of the additional options button 38 is provided in the FIG. 6 description. In the illustrated embodiment, the home screen comprises a snapshot 39 of recently uploaded purchase information. The snapshot 39 may provide the user with the ability to add additional purchase data if needed.

Referring now to FIG. 4, there is shown a demonstrative view of a search screen of an embodiment of the purchase receipt data system. When the search button 36 is engaged by the user, a category menu 41 is produced on the graphical user interface. The category menu 41 provides one or more categories by which purchase data may be searched. For example, the user may be able to search by the vendor or store name by engaging the VENDOR/STORE NAME option 42. Doing so will pull up a list of stores and vendors for which the user may review receipts or other purchase data. Alternatively, the user may search by any other category defined by the database of purchase data. For example, in the illustrated embodiment, the user may search for purchase data corresponding to a specific date, location, brand name, item, payment form, cost range, tax deduction category, or a custom-defined category such as “dining,” “recreation” or “major purchases.” Furthermore, the user may search by using two or more filters or qualifiers.

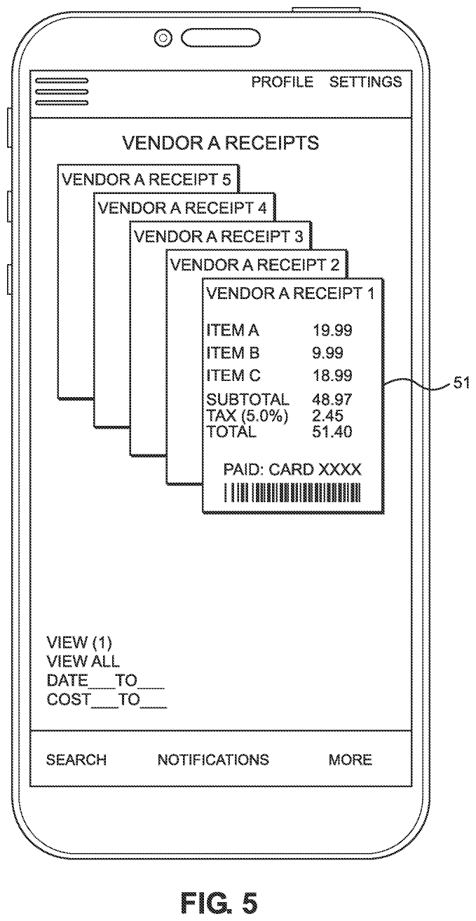

Referring now to FIG. 5, there is shown a demonstrative view of a vendor receipts screen of an embodiment of the purchase receipt data system. In the demonstrated embodiment, the graphical user interface is showing a plurality of receipts 51 corresponding to a selected vendor. When the user searches using the parameters discussed in the description of FIG. 4, he or she will be able to review the purchase data associated with the parameters. In the specific embodiment, a plurality of virtual receipts 51 are presented on the graphic user interface, such that the user may scroll through them.

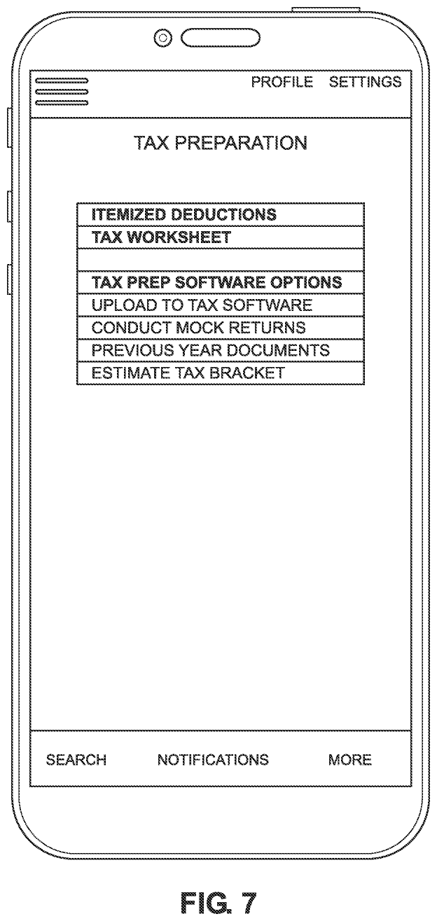

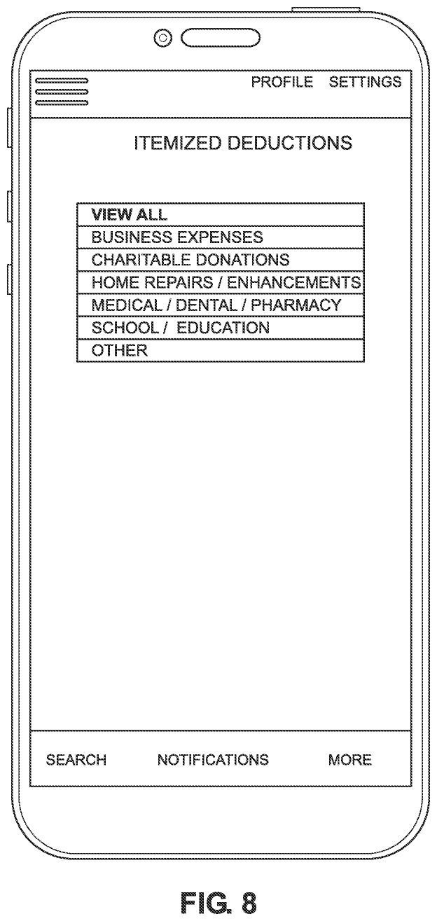

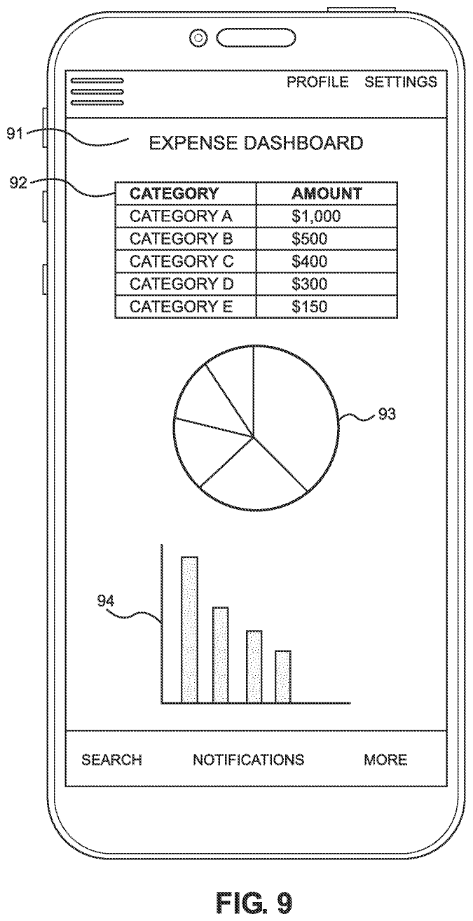

Referring now to FIG. 6, there is shown a demonstrative view of an additional options screen of an embodiment of the purchase receipt data system. When the additional options button 38 is engaged by the user, additional options 61 of the purchase receipt data system application are presented to the user. For example, the additional options 61 may include the option to photograph a physical receipt, or otherwise import receipt data. Furthermore, the additional options 61 may include tax preparations options (as discussed in FIG. 7 and FIG. 8). Additionally, the additional options 61 may include the ability to generate an expenses dashboard generated from purchase data organized into the database. An exemplary expense dashboard is shown and described in FIG. 9. Any number of additional options or functionalities may be present in the additional options screen.

Referring now to FIGS. 7 and 8, there are shown demonstrative views of a tax preparation options screen and an itemized deductions screen of an embodiment of the purchase receipt data system. The tax preparation options screen comprises a number of tax preparation options. In the illustrated embodiment, the purchase receipt data system application is configured to categorize itemized deductions, to upload the itemized deductions to a tax software, and to conduct a mock tax return. The tax preparation options may also include the ability to view tax worksheets, previous year tax documents and to estimate current and future tax implications. The itemized deductions screen, as shown in FIG. 8, provides an organized database of itemized deductions by category to assist the user in filling out a tax return or similar tax document.

Referring now to FIG. 9, there is shown a demonstrative view of an expense dashboard screen of an embodiment of the purchase receipt data system. The expense dashboard 91 comprises a plurality of graphical representations of purchase data. For example, in the demonstrated embodiment, the expense dashboard 91 comprises a category table 92 listing a category with an associated amount corresponding to the spending for that category. Additionally, in the shown embodiment, purchase data by category is presented in a pie chart 93. The pie chart 93 provides a visual representation of the proportions of spending associated with each category. Furthermore, a bar graph 94 is shown in the illustrated embodiment. The bar graph 94 illustrates a further visual representation of the proportions of spending associated with each category relative to each other. In further embodiments, alternate visual or data representations may be provided.

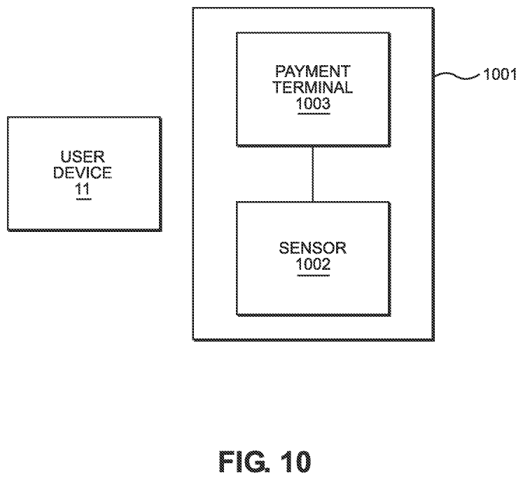

Referring now to FIG. 10, there is shown a diagrammatic view of a point-of-sale embodiment of the purchase receipt data system. In some embodiments, receipt data may be transmitted to the user device 11 directly from a point-of-sale system 1001. For example, the point-of-sale system 1001 may comprise a sensor 1002 on the payment terminal 1003, which is configured to transmit receipt data to the user device 11 when the user device 11 is tapped or otherwise brought into contact with the payment terminal 1003. As such, the user will not need to manually input the receipt data or rely upon an email or other manual transfer of the receipt data from the storefront.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A purchase receipt data system, comprising:
at least one user device;
each user device comprising at least one input device in operable connection with the user device;
the user device connected to a network;
a server connected to the network;
the server comprising a storage unit;
the storage unit comprising a computer-readable medium;
the computer-readable medium configured to execute an application;
the application configured to perform a set of steps;
the set of steps comprising:
gathering a set of purchase data;
categorizing the set of purchase data;
organizing the set of purchase data by category into a database;
organizing the database into a graphical user interface.

2. The purchase receipt data system of claim 1, wherein the purchase data is gathered from a database of electronic purchase receipts.

3. The purchase receipt data system of claim 1, wherein the purchase data is gathered from a plurality of physical purchase receipts.

4. The purchase receipt data system of claim 3, wherein a camera is utilized to gather data from the plurality of physical purchase receipts.

5. The purchase receipt data system of claim 1, wherein the user device is a mobile device.

6. The purchase receipt data system of claim 1, wherein the application is configured to categorize purchase data by purchase location.

7. The purchase receipt data system of claim 1, wherein the application is configured to categorize purchase data by purchase category.

8. The purchase receipt data system of claim 1, wherein the application is configured to gather purchase data through a user input form.

9. The purchase receipt data system of claim 1, wherein the application is configured to identify and categorize tax deductions.

10. The purchase receipt data system of claim 1, wherein purchase data is gathered and categorized utilizing an artificial intelligence system.

11. The purchase receipt data system of claim 1, wherein the database of purchase data may be printed via a printer.

12. The purchase receipt data system of claim 1, wherein the database of purchase data is exportable as a virtual document.
